(19) United States
(12) Patent Application Publication
(10) Pub. No.: US 2019/0321791 A1
(43) Pub. Date: Oct. 24, 2019

(54) APPARATUS AND METHOD FOR FORMING EMULSIONS

(71) Applicants: The Procter & Gamble Company, Cincinnati, OH (US); President and Fellows of Harvard College, Cambridge, MA (US)

(72) Inventors: John Christopher Wesner, Liberty Township, OH (US); Marco Caggioni, Cincinnati, OH (US); Hyomin Lee, Gyeongsanjbuk-do (KR)

(73) Assignee: President and Fellows of Harvard College, Cambridge, MA (US)

(21) Appl. No.: 15/957,092

(22) Filed: Apr. 19, 2018

(51) Int. Cl. B01F 5/06; B01F 17/00; B01F 3/08; B01F 13/00

(52) U.S. Cl. CPC B01F 5/0603; B01F 13/0059; B01F 3/0811; B01F 17/00

(57) ABSTRACT

An apparatus for creating an emulsion, including: an inlet chamber; a channel comprising a length L, height H, an inlet and an outlet, and walls having surface energies, the channel inlet adjacent to the inlet chamber. The channel inlet walls have a first surface energy and the outlet walls have a second surface energy substantially different from the first surface energy. An outlet chamber is disposed adjacent to the channel outlet, the outlet chamber height H2 being greater than the channel height H.

### FIELD OF THE INVENTION

The invention relates to methods and apparatus for forming emulsions. The invention relates particularly to micro fluidic methods and apparatus for forming multi-stage emulsions.

### BACKGROUND OF THE INVENTION

Membrane and other micro structures for the purpose of creating emulsions are known in the art. Such structures may be used to create small quantities of emulsions under certain conditions, but may not be well suited to the production of large quantities of desired emulsions. Such deices may also not be well suited to the production of multi stage emulsions where the first emulsion must be maintained as stable until it can be further emulsified. What is needed are methods and apparatus for the production of large quantities of desired multi stage emulsions.

### SUMMARY OF THE INVENTION

In one aspect, an apparatus for creating an emulsion, including: an inlet chamber; a channel comprising a length L, height H, an inlet and an outlet, and walls having surface energies, the channel inlet adjacent to the inlet chamber. The channel inlet walls have a first surface energy and the outlet walls have a second surface energy substantially different from the first surface energy. An outlet chamber is disposed adjacent to the channel outlet, the outlet chamber height H2 being greater than the channel height H.

### BRIEF DESCRIPTION OF THE DRAWINGS

FIG. 1 provides a plan view of a first embodiment of the invention.

FIG. 2 provides a plan view of a single channel according to one embodiment of the invention.

### DETAILED DESCRIPTION OF THE INVENTION

In one embodiment, the apparatus comprises an inlet chamber. The inlet chamber has a height, length and width. The inlet chamber is in fluid communication with one or more channels. Each channel comprises walls, an inlet and an outlet. The material of the surfaces of the channel(s) comprise a surface energy. The channel material may be selectively treated to alter the surface energy of the surfaces of a portion of the channel(s). In this manner, the surface energy of the channel inlet surfaces may be substantially different from the surface energy of the channel outlet surfaces. In one embodiment, the channel(s) may have a hydrophobic inlet and a hydrophilic outlet. In one embodiment, the channel(s) may have a hydrophilic inlet and a hydrophobic outlet. The channel(s) outlet(s) are in fluid communication with an outlet chamber. The outlet chamber has a height which is substantially greater than the height of the channel(s).

In one embodiment, the channels may be about 750 micro meters in length, 30 micro meters in width and 10 micro meters in height. The channels may have widened inlet and outlet areas to facilitate the intake and discharge of dispersed phase droplets as the apparatus is used to form emulsions.

Fluid may be supplied to the inlet chamber via one or more fluid supply lines. In one embodiment, the inlet chamber is supplied using a single supply line. The supplied fluid may comprise an emulsion having a continuous phase and a dispersed phase emulsified in the continuous phase.

In one embodiment, the inlet chamber may further comprise a static mixing element. The presence of a static mixing element may enable the use of a coarser emulsion as the supply fluid. The static mixing element may alter the characteristics of the supplied emulsion. The static mixer may yield an initial emulsion having a monodisperse dispersed phase or having a dispersed phase with a narrow droplet size range. In one embodiment, the static mixer comprises a post array device comprised of a fixed array of post elements arranged to disrupt the flow of the fluid from the supply inlet toward the channels for creating a monodisperse emulsion. Other static mixing elements may also be disposed in the inlet chamber for the same purpose. The supplied fluid progresses through the static mixing element and into the channel(s). During this progress, the dispersed phase may become more uniform in size as the droplets of the dispersed phase pass through the static mixer element. The droplets of the dispersed phase then pass through the channel(s) of the apparatus. The surface energy of the channel(s) inlet corresponds to the continuous phase of the supply emulsion such that the continuous phase will wet the channel(s) surfaces. The channel(s) outlet surface energy corresponds to the fluid present in the outlet chamber which will form the continuous phase of the double emulsion being formed in the apparats. As an example, a supplied oil in water emulsion will utilize an apparatus having hydrophilic channel inlets, hydrophobic channel outlets and an oil based fluid in the outlet chamber. In this example, the inlet hydrophilic surfaces will be wet out by the continuous phase of the supplied emulsion which will assist in stabilizing the droplets of the supplied emulsion. As the channel surface energy changes from hydrophilic to hydrophobic, at the channel outlet, the new continuous phase present in the outlet chamber, will wet the channel surfaces and droplets of the supplied emulsion dispersed phase pass along the channel wetted by the supplied continuous phase, double emulsion droplets having an inner payload of the supplied dispersed phase surrounded by a layer of shell of the supplied continuous phase will form and will be discharged into the outlet chamber.

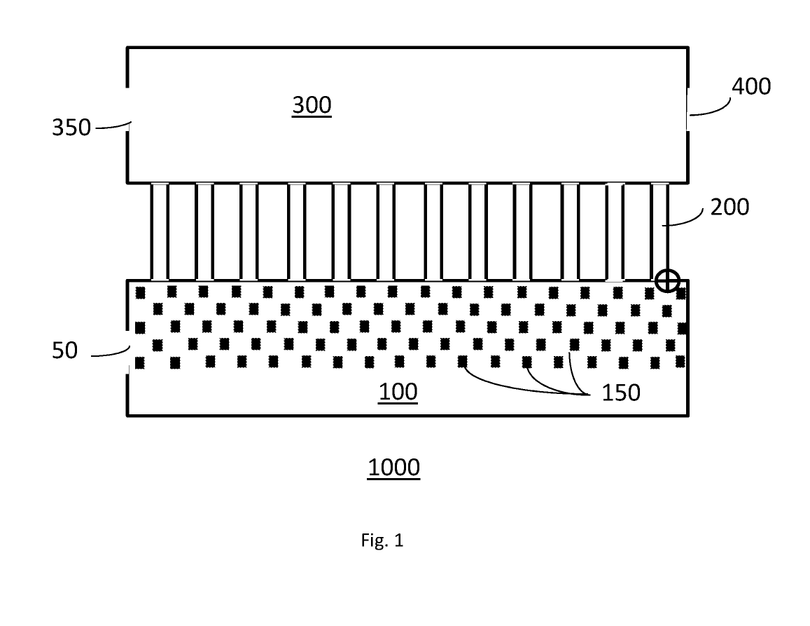

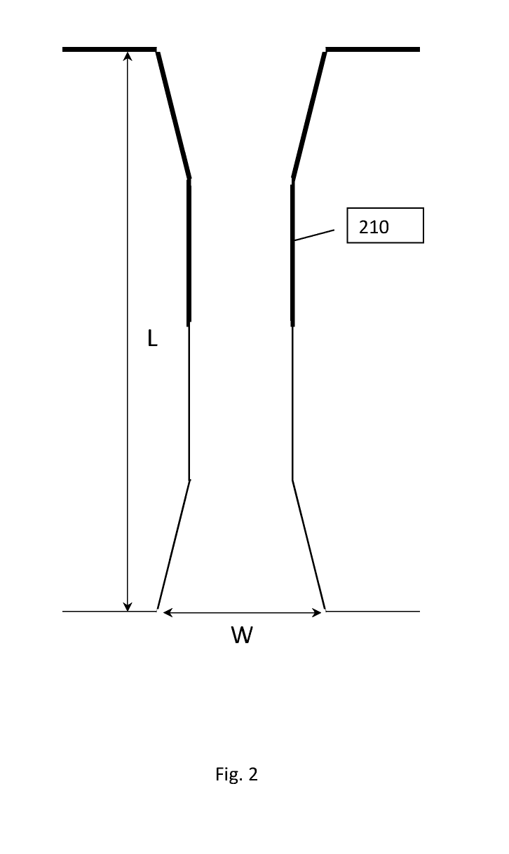

As illustrated in FIG. 1: the apparatus 1000 comprises a fluid supply 50, an inlet chamber 100, an optional static mixer—post array device 150, a plurality of channels 200 having a length L, a height H (not shown) and a width W, an outlet chamber 300 having a continuous phase inlet 350 and a fluid outlet 400. As illustrated in FIG. 2, the details of a single channel 200, the length L, the Width W and the channel outlet portions having a second surface energy which differs from the channel inlet portion surface energy.

The apparatus of the invention may be fabricated from polydimethylsiloxane (PDMS) using standard soft lithography processes. The changes to surface energy in the surfaces of the channels walls may be accomplished by selectively treating portions of the apparatus with a polyelectrolyte solution to obtain the desired surface energy changes.

Combinations:
A. An apparatus for creating an emulsion, the apparatus comprising:
   a. an inlet chamber;
   b. a channel comprising a length L, height H, an inlet and an outlet, and walls having surface energies, the channel inlet adjacent to the inlet chamber, wherein the channel inlet walls have a first surface energy and the channel outlet walls have a second surface energy substantially different from the first surface energy;
   c. an outlet chamber adjacent to the channel outlet, the height H2 of the outlet chamber being greater than the channel height H.
B. The apparatus according to paragraph A wherein the channel inlet walls comprises hydrophobic surfaces and the channel outlet walls comprises hydrophilic surfaces.
C. The apparatus according to any of paragraphs A or B wherein the channel inlet walls comprises hydrophilic surfaces and the channel outlet walls comprises hydrophobic surfaces.
D. The apparatus according to any of paragraphs A, B, or C further comprising a static mixer disposed adjacent to the inlet of the channels.
E. The apparatus according to any or paragraphs A, B, C, or D, wherein the static mixer comprises a post array device.
F. The apparatus according to any of paragraphs A, B, C, D, or E, comprising a plurality of channels comprising a length L, a first height H, an inlet and an outlet, and walls having surface energies, wherein the channel inlet walls have a first surface energy and the channel outlet walls have a second surface energy substantially different from the first surface energy, the channels disposed adjacent to each other wherein all channel inputs are disposed adjacent to a common inlet chamber.
G. The apparatus according to any of paragraphs A, B, C, D, E, or F, further comprising a static mixer disposed in the common inlet chamber.
H. The apparatus according to any of paragraphs A, B, C, D, E, F, or G, wherein the static mixer comprises a post array deice
I. The apparatus according to any of paragraphs A, B, C, D, E, F, G, or H, further comprising a single common emulsion inlet disposed adjacent to the common inlet chamber.
J. The apparatus according to any of paragraphs A, B, C, D, E, F, G, H, or I wherein the channel inlet walls comprises hydrophobic surfaces and the channel outlet walls comprises hydrophilic surfaces.
K. The apparatus according to any of paragraphs A, B, C, D, E, F, G, H, I, or J, wherein the channel inlet walls comprises hydrophilic surfaces and the channel outlet walls comprises hydrophobic surfaces.
L. The apparatus according to any of paragraphs A, B, C, D, E, F, G, H, I, J, or K, further comprising a common outlet chamber disposed adjacent to the channel outlets.
M. The apparatus according to any of paragraphs A, B, C, D, E, F, G, H, I, J, K, or L, wherein the common outlet chamber comprises a second height H2 greater than the first height H.
N. A method for forming a dual emulsion, the method comprising steps of:
   a. providing an apparatus comprising a plurality of channels comprising a length L, height H, and width W, an inlet and an outlet, and walls having surface energies, wherein the channel inlet walls have a first surface energy and the channel outlet walls have a second surface energy substantially different from the first surface energy, the channels disposed adjacent to each other wherein a plurality of channel inputs are disposed adjacent to a common inlet chamber and a plurality the channel outlets are disposed adjacent to a common outlet chamber, wherein the common outlet chamber contains a continuous phase fluid for the dual emulsion;
   b. forcing a first emulsion from the common inlet chamber, through the channels into the common outlet chamber.
O. The method according to paragraph N, wherein the step of providing an apparatus further comprises providing a post array device disposed in the common inlet chamber.
P. The method according to any of paragraphs N, or O, wherein the step of forcing a first emulsion through the channels comprises forcing a first emulsion through a single inlet into the common inlet chamber.
Q. The method according to any of paragraphs N, O, or P, wherein the common outlet chamber comprises a second height H2 greater than the first height H.
R. The method according to any of paragraphs N, O, P, or Q, wherein the step of providing an apparatus further comprises providing channels wherein the channel inlet walls comprises hydrophobic surfaces and the channel outlet walls comprises hydrophilic surfaces.
S. The method according to any of paragraphs N, O, P, Q, or R, wherein the step of providing an apparatus further comprises providing channels wherein the channel inlet walls comprises hydrophilic surfaces and the channel outlet walls comprises hydrophobic surfaces.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for creating an emulsion, the apparatus comprising:
a. an inlet chamber;
b. a channel comprising a length L, height H, an inlet and an outlet, and walls having surface energies, the channel inlet adjacent to the inlet chamber, wherein the channel inlet walls have a first surface energy and the channel outlet walls have a second surface energy substantially different from the first surface energy;
c. an outlet chamber adjacent to the channel outlet, the height H2 of the outlet chamber being greater than the channel height H.

2. The apparatus according to claim 1 wherein the channel inlet walls comprises hydrophobic surfaces and the channel outlet walls comprises hydrophilic surfaces.

3. The apparatus according to claim 1 wherein the channel inlet walls comprises hydrophilic surfaces and the channel outlet walls comprises hydrophobic surfaces.

4. The apparatus according to claim 1 further comprising a static mixer disposed adjacent to the inlet of the channels.

5. The apparatus according to claim 4, wherein the static mixer comprises a post array device.

6. The apparatus according to claim 1 comprising a plurality of channels comprising a length L, a first height H, an inlet and an outlet, and walls having surface energies, wherein the channel inlet walls have a first surface energy and the channel outlet walls have a second surface energy substantially different from the first surface energy, the channels disposed adjacent to each other wherein all channel inputs are disposed adjacent to a common inlet chamber.

7. The apparatus according to claim 6, further comprising a static mixer disposed in the common inlet chamber.

8. The apparatus according to claim 7, wherein the static mixer comprises a post array deice

9. The apparatus according to claim 6 further comprising a single common emulsion inlet disposed adjacent to the common inlet chamber.

10. The apparatus according to claim 6 wherein the channel inlet walls comprises hydrophobic surfaces and the channel outlet walls comprises hydrophilic surfaces.

11. The apparatus according to claim 6 wherein the channel inlet walls comprises hydrophilic surfaces and the channel outlet walls comprises hydrophobic surfaces.

12. The apparatus according to claim 6 further comprising a common outlet chamber disposed adjacent to the channel outlets.

13. The apparatus according to claim 6 wherein the common outlet chamber comprises a second height H2 greater than the first height H.

14. A method for forming a dual emulsion, the method comprising steps of:
a. providing an apparatus comprising a plurality of channels comprising a length L, height H, and width W, an inlet and an outlet, and walls having surface energies, wherein the channel inlet walls have a first surface energy and the channel outlet walls have a second surface energy substantially different from the first surface energy, the channels disposed adjacent to each other wherein a plurality of channel inputs are disposed adjacent to a common inlet chamber and a plurality the channel outlets are disposed adjacent to a common outlet chamber, wherein the common outlet chamber contains a continuous phase fluid for the dual emulsion;
b. forcing a first emulsion from the common inlet chamber, through the channels into the common outlet chamber.

15. The method according to claim 14 wherein the step of providing an apparatus further comprises providing a post array device disposed in the common inlet chamber.

16. The method according to claim 14 wherein the step of forcing a first emulsion through the channels comprises forcing a first emulsion through a single inlet into the common inlet chamber.

17. The method according to claim 14 wherein the common outlet chamber comprises a second height H2 greater than the first height H.

18. The method according to claim 14 wherein the step of providing an apparatus further comprises providing channels wherein the channel inlet walls comprises hydrophobic surfaces and the channel outlet walls comprises hydrophilic surfaces.

19. The method according to claim 14 wherein the step of providing an apparatus further comprises providing channels wherein the channel inlet walls comprises hydrophilic surfaces and the channel outlet walls comprises hydrophobic surfaces.
